(19) United States
(12) Patent Application Publication
(10) Pub. No.: US 2022/0163840 A1
(43) Pub. Date: May 26, 2022

(54) DISPLAYING SUBSTRATE, DISPLAY PANEL AND DISPLAYING DEVICE

(71) Applicants: Beijing BOE Display Technology Co., Ltd., Beijing (CN); BOE Technology Group Co., Ltd., Beijing (CN)

(72) Inventors: Zhan WEI, Beijing (CN); Shijun WANG, Beijing (CN); Bo FENG, Beijing (CN); Jun FAN, Beijing (CN); Yang WANG, Beijing (CN); Tengfei DING, Beijing (CN); Yi LIU, Beijing (CN); Xinlan YANG, Beijing (CN); Gongda CHEN, Beijing (CN); Guangshuang LV, Beijing (CN); Yuke TAI, Beijing (CN)

(21) Appl. No.: 17/349,824

(22) Filed: Jun. 16, 2021

(30) Foreign Application Priority Data
Nov. 26, 2020 (CN) 202011348542.X

(51) Int. Cl. G02F 1/1335; G02F 1/1362

(52) U.S. Cl. CPC G02F 1/133512; G02F 1/136209; G02F 1/133514

(57) ABSTRACT

A displaying substrate, a display panel and a displaying device. The displaying substrate comprises: a base plate, wherein the base plate comprises a display region, a non-display region, and a transition region located between the display region and the non-display region. Pixel units are disposed in the transition region on the base plate and each comprise multiple sub-pixel units, and first light shielding layers are disposed in the sub-pixel units and are used to divide the sub-pixel units into multiple luminescent regions.

### CROSS-REFERENCE TO RELATED APPLICATIONS

The disclosure Claims the priority of a Chinese patent application filed in the China National Intellectual Property Administration on Nov. 26, 2020 with application number 202011348542.X and application name “A Displaying Substrate, Display Panel and Displaying Device”, the entire contents of which are hereby incorporated by reference.

### TECHNICAL FIELD

The present disclosure relates to the technical field of display, in particular to a displaying substrate, a display panel and a displaying device.

### BACKGROUND

At present, “full-screen” has become the development trend of smart portable devices, and a series of devices equipped with special-shaped screens designed with water drops, fringes, holes and the like come into the market successively.

### SUMMARY

The present disclosure provides a displaying substrate, a display panel and a displaying device to eliminate a sense of aliasing on the edge.

The embodiment of the disclosure provides a displaying substrate, comprising:

a base plate comprising a display region, a non-display region, and a transition region located between the display region and the non-display region;

wherein, pixel units are disposed in the transition region on the base plate and each comprise multiple sub-pixel units, and first light shielding layers are disposed in the sub-pixel units and are used to divide the sub-pixel units into multiple luminescent regions.

Optionally, the sub-pixel units have a same aperture ratio, wherein the aperture ratio of each said sub-pixel unit is a ratio of a first area to a second area of the sub-pixel unit, the first area of the sub-pixel unit is a sum of areas of orthographic projections of the multiple luminescent regions of the sub-pixel unit on the base plate, and the second area of the sub-pixel unit is an area of an orthographic projection of the sub-pixel unit on the base plate.

Optionally, each said pixel unit comprises a first region and a second region separated by a preset boundary, the first region is located on a side, close to the display region, of the preset boundary, the second region is located on a side, close to the non-display region, of the preset boundary, and an absolute value of a difference between the aperture ratio of the sub-pixel units and an effective display ratio of the pixel unit is smaller than a preset threshold;

wherein, the effective display ratio is a ratio of an area of the first region to a total area, and the total area is the sum of the area of the first region and an area of the second region.

Optionally, second light shielding layers are disposed between the sub-pixel layers and are used to form multiple open regions, and orthographic projections of the sub-pixel units in a plane, where the second light shielding layers are located, are located in different open regions.

Optionally, the first light shielding layers and the second light shielding layers are disposed on a same layer and are made of a same material.

Optionally, the first light shielding layers and the second light shielding layers are of an integrated structure.

Optionally, filter layers in different colors are disposed in the sub-pixel units.

Optionally, the second light shielding layers are black matrixes of the displaying substrate.

Optionally, orthographic projections of the luminescent regions on the base plate are polygonal or circular.

Optionally, orthographic projections of the first light shielding layers on the base plate are in any one of a linear shape, a cross shape and a # shape.

Optionally, a maximum size of orthographic projections of the luminescent regions on the base plate is smaller than or equal to 3 μm.

Optionally, a size of the first light shielding layer between every two adjacent said luminescent regions in a first direction is smaller than or equal to 1 μm, wherein the first direction is a direction of a connecting line of centers of the two adjacent said luminescent regions.

Optionally, a size of the first light shielding layers in a second direction is greater than or equal to 1 μm and smaller than or equal to 5 μm, wherein the second direction is perpendicular to the base plate.

The embodiment of the disclosure further provides a display panel, comprising the above displaying substrate.

Optionally, further comprising a cell substrate opposite to the displaying substrate, and a liquid crystal filled between the displaying substrate and the cell substrate.

Optionally, when the displaying substrate is an array substrate, the cell substrate is a color filter substrate; or

when the displaying substrate is a color filter substrate, the cell substrate is an array substrate.

The embodiment of the disclosure further provides a displaying device, comprising the above display panel.

The above description is only an overview of the technical solution of this disclosure, which can be implemented according to the contents of the specification in order to understand the technical means of this disclosure more clearly, and in order to make the above and other objects, features and advantages of this disclosure more obvious and understandable, the detailed description of this disclosure will be given below.

### BRIEF DESCRIPTION OF THE DRAWINGS

To more clearly explain the technical solutions of the embodiments of the present disclosure, drawings used for describing the embodiments of the present disclosure will be briefly introduced below. Obviously, the drawings in the following description merely illustrate some embodiments of the present disclosure, and those ordinarily skilled in the art may obtain other drawings according to the following ones without creative labor.

FIG. 1 illustrates a planar structural diagram of sub-pixel units in the related art;

FIG. 2 illustrates a principle diagram of the generation of a sense of aliasing on the edge in the related art;

FIG. 3 illustrates a planar structural diagram of a displaying substrate in one embodiment of the present disclosure;

FIG. 4 illustrates a planar structural diagram of one pixel unit in a transition region in one embodiment of the present disclosure; and

FIG. 5 illustrates a schematic diagram of a grayscale transition of the pixel unit in the transition region in one embodiment of the present disclosure.

### DETAILED DESCRIPTION

To gain a better understanding of the above purposes, features and advantages of the present disclosure, the present disclosure will be described in further detail below in conjunction with the accompanying drawings and specific implementations. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

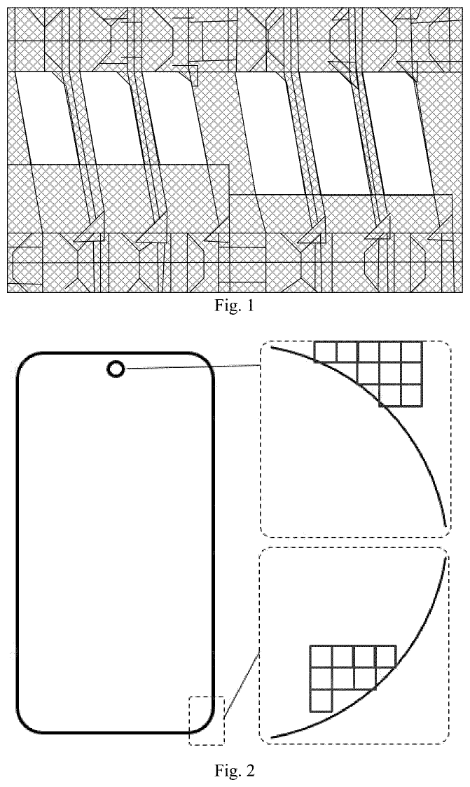

The inventor finds that, because the sub-pixel units in the prior art are approximately rectangular as shown in FIG. 1, a sense of aliasing invisible to the naked eyes may be generated on the special-shaped edge or the arc edge of the peripheral R corner of screens, as shown in FIG. 2.

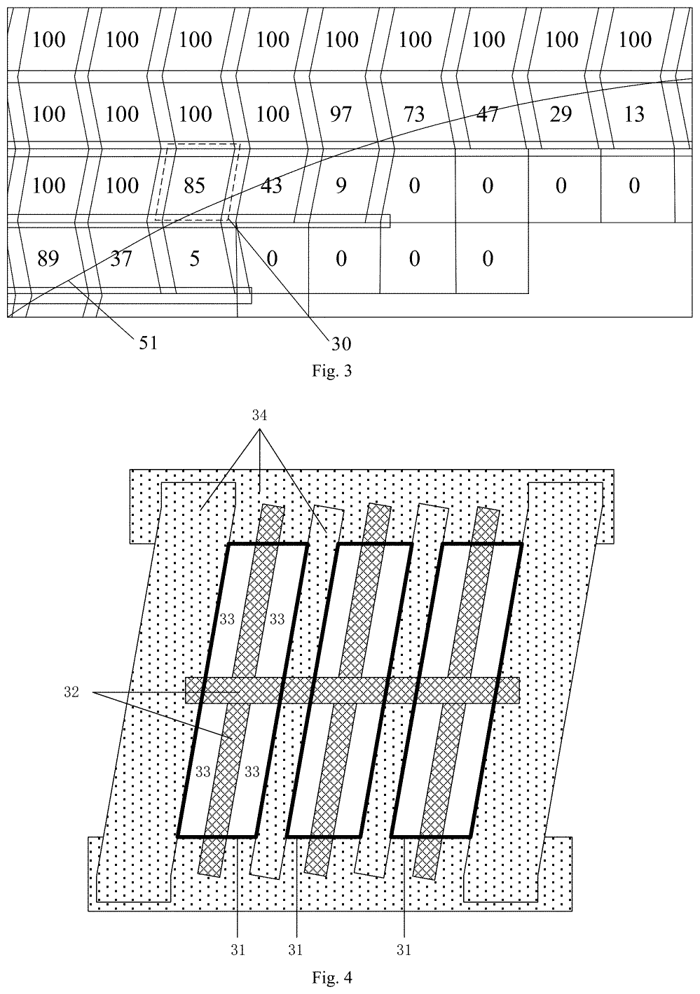

To eliminate the sense of aliasing on the edge, one embodiment of the present disclosure provides a displaying substrate. The displaying substrate includes: a base plate, wherein the base plate includes a display region, a non-display region, and a transition region located between the display region and the non-display region, and pixel units 30 are disposed in the transition region on the base plate, as shown in FIG. 3.

As shown in FIG. 3, units marked by 100 are located in the display region, units marked by 0 are located in the non-display region, and units marked by 0-100 are the pixel units 30 located in the transition region. The pixel units 30 may be any units intersecting with a preset boundary 51, and are all located in the transition region.

Refer to FIG. 4 which illustrates a planar structural diagram of one pixel unit 30 in the transition region. As shown in FIG. 4, the pixel unit 30 includes multiple sub-pixel units 31, wherein light shielding layers 32 are disposed in the sub-pixel units 31 and are used to divide the sub-pixel units 31 into multiple luminescent regions 33.

In actual application, the light shielding layer 32 is disposed in each sub-pixel unit 31 in the pixel unit 30 and is used to divide each sub-pixel unit 31 into multiple luminescent regions 33.

The pixel unit 30 shown in FIG. 4 includes three sub-pixel units 31, and each sub-pixel unit 31 is divided into four luminescent regions 33 by the first light shielding layer 32 disposed therein.

By dividing the large luminescent region, namely the sub-pixel unit 31, into multiple small luminescent regions 33, the luminescent regions become finer. Based on the constant sensitivity function (CSF) that the contrast sensitivity value of human eyes will be decreased with the increase of the spatial frequency, the size of the luminescent regions obtained after division becomes smaller, that is, the spatial frequency is increased, so the contrast sensitivity value of human eyes is decreased.

According to the displaying substrate provided by this embodiment, the first light shielding layers divide the sub-pixel units into multiple luminescent regions with a smaller size, which in turn decreases contrast sensitivity value of human eyes based on the CSF, thus eliminating a sense of aliasing on the edge.

Wherein, orthographic projections of the luminescent regions 33 on the base plate may be polygonal, circular, or the like. The luminescent regions 33 in FIG. 4 are in a parallelogram shape. This embodiment has no limitation to the specific shape of the luminescent regions 33.

Orthographic projections of the first light shielding layers 32 on the base plate may be in at least one of the following shapes: linear shape, cross shape and # shape, and this embodiment has no limitation to the specific shape of the first light shielding layers 32. In FIG. 4, the orthographic projections of the first light shielding layers 32 on the base plate are cross-shaped, and each cross-shaped first light shielding layer 32 divides the corresponding sub-pixel unit 31 into four luminescent regions 33.

The maximum size of the orthographic projections of the luminescent regions 33 on the base plate may be smaller than or equal to 3 μm. With the decrease of the size of the luminescent regions 33, the contrast sensitivity value of human eyes will be decreased, which is beneficial for completely eliminating a sense of aliasing on the edge.

In a specific implementation, the size of the first light shielding layer 32 located between every two adjacent luminescent regions 33 in a first direction may be smaller than or equal to 1 μm, wherein the first direction is the direction of a connecting line of the centers of the two adjacent luminescent regions 33.

In a specific implementation, the size of the first light shielding layers 32 in a second direction may be greater than or equal to 1 μm and smaller than or equal to 5 μm, wherein the second direction is perpendicular to the base plate. That is, the thickness of the first light shielding layers 32 may be greater than or equal to 1 μm and smaller than or equal to 5 μm.

To avoid color cast, in one optional implementation, all the sub-pixel units 31 in the same pixel units 30 have the same aperture ratio, wherein the aperture ratio of each sub-pixel unit 31 is a ratio of a first area to a second area of the sub-pixel unit 31, the first area of the sub-pixel unit 31 is the sum of the areas of the orthographic projections of the multiple luminescent regions 33 of the sub-pixel unit 31 on the base plate, and the second area of the sub-pixel unit 31 is the area of the orthographic projection of the sub-pixel unit 31 on the base plate.

The sub-pixel units 31 in the same pixel units 30 have the same aperture ratio, that is, the first light shielding layers 32 in the sub-pixel units 31 have the same shielding ratio. In actual application, the light shielding area of the first light shielding layers 32 may be determined according to the aperture ratio of the sub-pixel units 31 and the areas of the orthographic projections of the sub-pixel units 31 on the base plate.

When the multiple sub-pixel units 31 in the same pixel unit 30 are respectively a red sub-pixel unit, a green sub-pixel unit and a blue sub-pixel unit, the same aperture ratio ensures that the color display of a display screen is more natural and free of color cast.

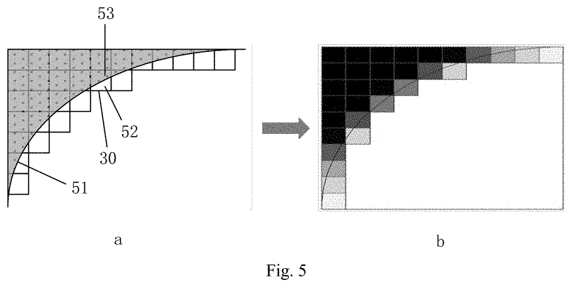

To ensure a smooth transition of the display screen from the display region to the non-display region, in one optional implementation, the pixel unit 30 may comprise a first region 52 and a second region 53 which are separated by a preset boundary 51, as show in FIG. 5a, wherein the first region 52 is located on a side, close to the display region, of the preset boundary 51, the second region 53 is located on a side, close to the non-display region, of the preset boundary 51, and the absolute value of a difference between the aperture ratio of the sub-pixel units 31 in the pixel unit 30 and an effective display ratio of the pixel unit 30 is smaller than a preset threshold; wherein, the effective display ratio is a ratio of the area of the first region 52 to the area of a total area, and the total area is the sum of the area of the first region 52 and the area of the second region 53.

In a specific implementation, the preset threshold may be 0, that is to say, the aperture ratio of the sub-pixel units 31 in the pixel unit 30 is equal to the effective display ratio of the pixel unit 30. It should be noted that the specific value of the preset threshold may be determined as actually needed, and this embodiment has no limitation to the specific value of the preset threshold.

Referring to FIG. 5a, the pixel unit 30 intersects with the preset boundary 51 and is divided by the preset boundary 51 into a first region 52 close to the display region and a second region 53 close to the non-display region; the effective display ratio TA=SA/(SA+SB) of the pixel unit 30 may be determined by calculating the area SA of the first region 52 and the area SB of the second region 53, and then the aperture ratio of the sub-pixel units 31 is determined. In actual application, the light shielding area of the first light shielding layers 32 may be determined according to the aperture ratio of the sub-pixel units 31 and the areas of the orthographic projections of the sub-pixel units 31 on the base plate.

It should be noted that the sum of the area of the first region 52 and the area of the second region 53 may be the area of the whole pixel unit 30, and in this case, the first region 52 and the second region 53 each comprise a transmitting region and a non-transmitting region; or, the sum of the area of the first region 52 and the area of the second region 53 may be the aperture area of the pixel unit 30, and in this case, the first region 52 and the second region 53 each only comprise a transmitting area.

Refer to FIG. 5b which illustrates a schematic diagram of a grayscale transition of the pixel unit 30 in the transition region. Wherein, the display grayscale of the pixel unit 30 in FIG. 5b may be determined as follows: a relative transmittance list under different display grayscales is figured out according to display digits (such as 0-255) and a Gamma curve (such as Gamma=2.2), then the effective display ratio TA is taken as a target relative transmittance, and finally, a target grayscale closest to the target relative transmittance is selected from the list and is taken as the display grayscale of the pixel unit 30.

Specifically, the display grayscale of pixels in the display area is set to 255, and the relative transmittance of the display area is set to 100%; the display grayscale of pixels in the non-display area is set to 0, and the relative transmittance of the non-display region is set to 0%; the effective display ratio of the pixel units 30 in the transition region is used as a target relative transmittance, and a target grayscale of the pixel units 30 is determined according to the list to obtain FIG. 5b. As can be seen from FIG. 5b, a smooth transition of the display screen from the display region to the non-display region is realized. Thus, a smooth transition from the display region to the non-display region may be realized in the display process by determining the aperture ratio of the sub-pixel units in the pixel unit according to the effective display ratio of the pixel unit 30.

In actual application, the light shielding area of the first light shielding layers 32 may be adjusted according to the effective display ratio of the pixel units 30 to enable the pixel units 30 in the transition region to realize a smooth transitional display effect.

In an optional implementation, as shown in FIG. 4, second light shielding layers 34 are disposed between the sub-pixel units 31 and are used to form multiple open regions, and orthographic projections of the sub-pixel units 31 on a plane, where the second light shielding layers 34 are located, are located in different open regions.

The open regions formed by the second light shielding layers 34 correspond to the sub-pixel units 31 one by one. The second light shielding layers 34 may be black matrixes of the displaying substrate.

To simplify the preparation process, the first light shielding layers 32 and the second light shielding layers 34 are disposed on the same layer and are made of the same material. The first light shielding layers 32 and the second light shielding layers 34 are of an integrated structure.

It should be noted that the first light shielding layers 32 and the second light shielding layers 34 in these embodiments are all used for shielding light. The first light shielding layers 32 and the second light shielding layers 34 may be disposed on different layers or be made of different materials. For example, the second light shielding layers 34 are black matrixes, and the first light shielding layers are formed by the same process with grid lines or data lines on an array substrate.

The displaying substrate provided by this embodiment may be an array substrate or a color filter substrate. When the displaying substrate is a color filter substrate, filter layers in different colors may be disposed in the sub-pixel units 31 in the pixel unit 30. For example, a red filter layer is disposed in the red sub-pixel unit, a green filter layer is disposed in the green sub-pixel layer, and a blue filter layer is disposed in the blue sub-pixel unit.

Another embodiment of the present disclosure provides a display panel comprising the displaying substrate in any one embodiment mentioned above.

In a specific implementation, the display panel provided by this embodiment may be an LCD display panel, an OLED display panel, or the like. When the display panel is an LCD display panel, the display panel may further comprise: a cell substrate opposite to the displaying substrate, and a liquid crystal filled between the displaying substrate and the cell substrate.

Wherein, when the displaying substrate is an array substrate, the cell substrate is a color filter substrate; or, when the displaying substrate is a color filter substrate, the cell substrate is an array substrate.

Another embodiment of the present disclosure further provides a displaying device comprising the display panel described in any one embodiment.

It should be noted that the displaying device in this embodiment may be any products or components with a 2D or 3D display function, such as electronic paper, a mobile phone, a tablet personnel computer, a television, a notebook computer, a digital photo frame and a navigator.

The embodiments of the present disclosure provide a displaying substrate, a display panel and a displaying device. The displaying substrate includes a base plate, wherein the base plate includes a display region, a non-display region, and a transition region disposed between the display region and the non-display region; pixel units are disposed in the transition region on the base plate and each comprise multiple sub-pixel units, and first light shielding layers are disposed in the sub-pixel units and are used to divide the sub-pixel units into multiple luminescent regions. According to the technical solution of the present disclosure, the first light shielding layers divide the sub-pixel units into multiple luminescent regions with a smaller size, which in turn decreases contrast sensitivity value of human eyes based on the CSF, thus eliminating a sense of aliasing.

The embodiments in this specification are described progressively, the differences from other embodiments are emphatically stated in each embodiment, and the similarities of these embodiments may be cross-referenced.

Finally, it should be noted that relational terms such as “first” and “second” in this specification are merely used to distinguish one entity or operation from the other one, and do not definitely indicate or imply that these entities or operations have any actual relations or sequences. In addition, the term “comprise” or “include” or other variations are intended to refer to non-exclusive inclusion, so that a process, method, article or device comprising a series of elements not only includes these elements listed, but also includes other elements that are not clearly listed, or inherent elements of the process, method, article or device. Unless otherwise clearly specified, an element defined by the expression “comprise a” shall not exclusive of other identical elements in a process, method, article or device comprising said element.

The displaying substrate, the display panel and the displaying device provided by the present disclosure are introduced in detail above, specific examples are used in this specification to expound the principle and implementation of the present disclosure, and the description of the above embodiments is merely used to assist those skilled in the art in understanding the method and core concept thereof of the present disclosure. In addition, those ordinarily skilled in the art can make changes to the specific implementation and application scope based on the concept of the present disclosure. So, the contents of the specification should not be construed as limitations of the present disclosure.

1. A displaying substrate, comprising:
a base plate comprising a display region, a non-display region, and a transition region located between the display region and the non-display region;
wherein, pixel units are disposed in the transition region on the base plate and each comprise multiple sub-pixel units, and first light shielding layers are disposed in the sub-pixel units and are used to divide the sub-pixel units into multiple luminescent regions;
wherein the sub-pixel units have a same aperture ratio, wherein the aperture ratio of each said sub-pixel unit is a ratio of a first area to a second area of the sub-pixel unit, the first area of the sub-pixel unit is a sum of areas of orthographic projections of the multiple luminescent regions of the sub-pixel unit on the base plate, and the second area of the sub-pixel unit is an area of an orthographic projection of the sub-pixel unit on the base plate;
wherein each said pixel unit comprises a first region and a second region separated by a preset boundary, the first region is located on a side, close to the display region, of the preset boundary, the second region is located on a side, close to the non-display region, of the preset boundary, and an absolute value of a difference between the aperture ratio of the sub-pixel units and an effective display ratio of the pixel unit is smaller than a preset threshold;
wherein, the effective display ratio is a ratio of an area of the first region to a total area, and the total area is the sum of the area of the first region and an area of the second region;
wherein a light shielding area of each of the first light shielding layers is determined according to the effective display ratio of the pixel unit and the area of the orthographic projection of the sub-pixel unit on the base plate.

2. (canceled)

3. (canceled)

4. The displaying substrate according to claim 1, wherein second light shielding layers are disposed between the sub-pixel layers and are used to form multiple open regions, and orthographic projections of the sub-pixel units in a plane, where the second light shielding layers are located, are located in different open regions.

5. The displaying substrate according to claim 4, wherein the first light shielding layers and the second light shielding layers are disposed on a same layer and are made of a same material.

6. The displaying substrate according to claim 5, wherein the first light shielding layers and the second light shielding layers are of an integrated structure.

7. The displaying substrate according to claim 4, wherein filter layers in different colors are disposed in the sub-pixel units.

8. The displaying substrate according to claim 4, wherein the second light shielding layers are black matrixes of the displaying substrate.

9. The displaying substrate according to claim 1, wherein orthographic projections of the luminescent regions on the base plate are polygonal or circular.

10. The displaying substrate according to claim 1, wherein orthographic projections of the first light shielding layers on the base plate are in any one of a linear shape, a cross shape and a # shape.

11. The displaying substrate according to claim 1, wherein a maximum size of orthographic projections of the luminescent regions on the base plate is smaller than or equal to 3 μm.

12. The displaying substrate according to claim 1, wherein a size of the first light shielding layer between every two adjacent said luminescent regions in a first direction is smaller than or equal to 1 μm, wherein the first direction is a direction of a connecting line of centers of the two adjacent said luminescent regions.

13. The displaying substrate according to claim 1, wherein a size of the first light shielding layers in a second direction is greater than or equal to 1 μm and smaller than or equal to 5 μm, wherein the second direction is perpendicular to the base plate.

14. A display panel, comprising the displaying substrate according to claim 1.

15. The display panel according to claim 14, further comprising a cell substrate opposite to the displaying substrate, and a liquid crystal filled between the displaying substrate and the cell substrate.

16. The display panel according to claim 14, wherein, when the displaying substrate is an array substrate, the cell substrate is a color filter substrate; or
when the displaying substrate is a color filter substrate, the cell substrate is an array substrate.

17. A displaying device, comprising the display panel according to claim 14.
